(19) United States
(12) Patent Application Publication
(10) Pub. No.: US 2017/0196275 A1
(43) Pub. Date: Jul. 13, 2017

(54) HEATED CLOTHING

(71) Applicants: Andrew Wei Tam, Pickering (CA); Adam Walter Crossley, Pickering (CA)

(72) Inventors: Andrew Wei Tam, Pickering (CA); Adam Walter Crossley, Pickering (CA)

(21) Appl. No.: 15/405,964

(22) Filed: Jan. 13, 2017

Related U.S. Application Data
(60) Provisional application No. 62/278,108, filed on Jan. 13, 2016.

(51) Int. Cl. A41D 13/005; A41D 1/06; A41D 27/20; A41D 23/00; A41F 9/00; H01M 2/34; A41D 19/015

(52) U.S. Cl. CPC A41D 13/0058; H01M 2/34; H01M 2/348; A41D 13/0051; A41D 1/06; A41D 19/01535; A41D 23/00; A41F 9/002; A41D 27/205; H01M 2220/30

(57) ABSTRACT

An electrically-heated clothing/pants and its accessories, and the electric heating component in the electrically-heated clothing/pants and its accessories is an infrared laminate electric heating component, and the infrared laminate electric heating component is consisting of a conducting element and an infrared laminate.

### CROSS-REFERENCE TO RELATED APPLICATIONS

This application claims the benefit of U.S. Provisional Application No. 62/278,108, filed on Jan. 13, 2016. The entire disclosure of the above application is incorporated herein by reference.

### FIELD

The present disclosure relates to a heated clothing system and more particularly to IR heated clothing using a specific heat retaining and reflection system.

### BACKGROUND

This section provides background information related to the present disclosure which is not necessarily prior art. Currently electrically-heated clothing has multiple types of electric heating devices on the market. And wherein the electric heating device may further be of four types: laid electric heating wire, superconductive pellet, knitting conductive yarn and rubber electric heating component in which the laid electric heating wire forms a high temperature via its contact heating by the way of utilization of laying down the electric heating wire in loops, but the present laid electric heating wire has several common disadvantages comprising: (1) the electric heating wire unevenly distributed leads to heat unevenly and cause to the effect of local overheating; (2) the electric heating wire doesn't have the waterproof itself, and if there is no additional waterproof clothing coated on the electric heating wire, the electric heating wire will produce metal oxidation corrosion in moist environment such as washing the clothes; (3) the electric heating wire sewed in the clothes, coupled with its hard characteristic, influences the shape and touch of the clothes; (4) there is any adhesive force between the electric heating wire and the clothes, thus the electric heating wire is easily dissociated from the clothes; (5) while bending the electric heating wire many times, the bending portion of the electric heating wire is broken easily and cause short circuit and leakage of electricity. Although the lighter carbon fiber heater has replaced the electric heating wire as the improvement technology of heating tools, but the disadvantages of the lighter carbon fiber heater are prohibitive, easily broken while receiving the force hit, absence of ductility and do not be supported under too large stress.

Moreover, the rubber electric heating component is the safest heater known today. The rubber electric heating component is made by a compounded rubber pressed and rolled to shape and the wire is embedded in the rubber to form many contacts without circuit problems, the temperature disperses on each area of the rubber equally. Although the rubber electric heating component has solder contacts, but the solder point temperature doesn't form the aggregate temperature, the rubber electric heating component may be bended many times without producing the fracture and short circuit condition, the rubber material also has better wear resistance, higher flexibility, higher tensile strength and elongation rate.

In addition, in order to keep the human body safe from the electric heating devices, there is one layer or more layers of textiles added between the human body and the electric heating devices, but it will increase the distance between the human body and the electric heating devices and cause the warm ineffectively. Therefore, as previously mentioned, it need to develop a new electrically-heated device for solving many problems as mentioned above.

### SUMMARY

This section provides a general summary of the disclosure, and is not a comprehensive disclosure of its full scope or all of its features.

In view of the above known problems, the purpose of the invention is to provide an electrically-heated clothing/pants and its accessories, and the electric heating component in the electrically-heated clothing/pants and its accessories is an infrared laminate electric heating component, and the infrared laminate electric heating component is consisting of a conducting element and an infrared laminate. Apart from its better electrical isolation, the infrared laminate also has better heat conduction and may absorb local thermal energy produced from the conducting element and thermal energy is evenly distributed in the infrared laminate, so it could improve the disadvantage about local overheating, no heat retaining function and no prevention for high temperature while using the electrically-heated clothing/pants and its accessories, the user's surface contacted with the infrared laminate may be heated uniformly, the user is not scalded by the infrared laminate and the infrared laminate may keep the specific body areas warm. In addition, because the infrared laminate has better waterproof function, the electrically-heated clothing/pants will be washed in moist environment such as washing the clothes.

Another purpose of the invention is to provide an improved heater structure of the electrically-heated clothing/pants and its accessories, wherein the conducting element includes but not limited to the cable line, metal alloy foil, conductive adhesive or metal oxide semiconductor, and while the electrically-heated clothing/pants is received the force hit, the infrared laminate may be the buffer for preventing the conducting element from breakage due to bending or hitting the conducting element. The infrared laminate of the infrared laminate electric heating component may endure temperature up to 250.degree. C., so even if the conducting element has sudden overheating condition, the structure of the infrared laminate still may maintain better stability.

In a first aspect of the invention, the invention of the electrically-heated clothing comprises: a clothing, at least one battery, at least one infrared laminate heater, at least one control element. The at least one control element set on the clothing is electrically connected with at least one battery and at least one infrared laminate heater; wherein the power of at least one battery may be transferred to at least one infrared laminate heater by turning on at least one control element for converting electrical power to heat, wherein the at least one battery may be a 5V lithium battery.

In a second aspect of the invention, the invention of the electrically-heated pants comprises: a pair of pants, at least one battery, at least one infrared laminate heater, at least one control element. The at least one control element set on the pants is electrically connected with at least one battery and at least one infrared laminate heater; wherein the power of at least one battery may be transferred to at least one infrared laminate heater by turning on at least one control element for converting electrical power to heat.

In a third aspect of the invention, the invention of the electrically-heated accessory comprises: an accessory, at least one battery, at least one infrared laminate heater, at least one control element. The at least one control element set on the accessory is electrically connected with at least one battery and at least one infrared laminate heater; wherein the power of at least one battery may be transferred to at least one infrared laminate heater by turning on at least one control element for converting electrical power to heat. In one embodiment, the accessory may further be a belt, gloves and scarf. In one embodiment, some accessories include a bandage, and the bandage may be used for placing the battery.

In a fourth aspect of the invention, the control element of electrically-heated clothing/pants and its accessories further includes: a processor, a temperature detector and a temperature preventer, wherein the temperature detector is coupled with the processor for detecting and maintaining the temperature of the infrared laminate heater, and therefore the infrared laminate heater may keep a constant temperature; the temperature preventer is also coupled with the processor, while the temperature of the infrared laminate heater is abnormal (e.g. excess temperature), the temperature preventer will produce a signal to the processor to disconnect the power source of the battery. In one embodiment, the at least one infrared laminate heater comprises an infrared laminate and a conducting element, wherein the conducting element may further be a cable line, a metal alloy foil, a conductive adhesive or a metal oxide semiconductor. The control element performs multi-stage constant temperature regulation and provides prevention for the abnormal temperature to control electrical power which is transmitted from at least one battery to at least one infrared laminate heater and achieve the effect of temperature constant and control. Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is illustrated as a diagram of basic structure of an electrically-heated clothing according to the present teachings;

FIG. 2 is illustrated as a diagram of basic laminate structure of an electrically-heated pair of pants according to the present teachings;

FIGS. 3a and 3b is illustrated an electrically-heated carbon fiber IR heater;

FIG. 4 is illustrated a perspective view of the heater element shown in FIG. 3b electrically-heated accessory according to the present teachings; and

FIGS. 5a-5g are diagrams of infrared laminate heater structure used in various garments; and

FIG. 6 represents an ear piece using heaters according to the present teachings.

Corresponding reference numerals indicate corresponding parts throughout the several views of the drawings.

### DETAILED DESCRIPTION

Example embodiments will now be described more fully with reference to the accompanying drawings.

An implementation of the invention is illustrated by the following specific embodiments, the person who is familiar with the technique may easily realize the efficiency and its advantages disclosed from the specification content. The invention also may use other specific embodiments to utilize and implement, each detail illustrated in the specification may be applied based on different needs and various kinds of modifications and alterations are not departed under the spirit of the invention.

Some sample embodiments of the invention will now be described in greater detail. Nevertheless, it should be recognized that the present invention can be practiced in a wide range of other embodiments besides those explicitly described, and the scope of the present invention is expressly not limited expect as specified in the accompanying claims.

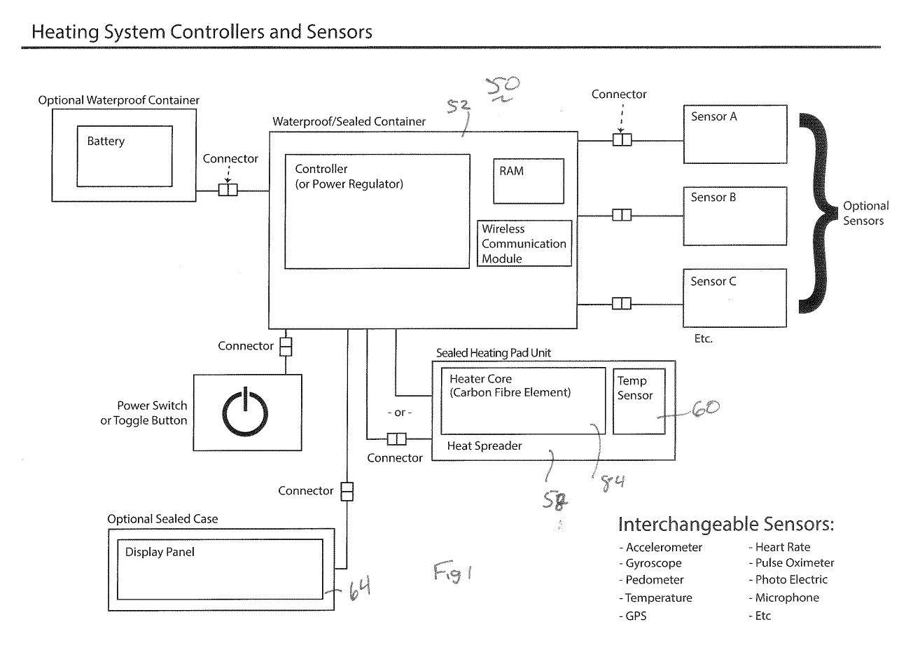

As shown in FIG. 1, it is illustrated as a diagram of basic structure the system 50 for electrically-heated clothing. The system 50 contains a circuit 52 in the form of a processor having RAM and a wireless communication module. The circuit 52 is connected to a rechargable battery which provides 9-24 volts to supply current to the IR heating elements. Associated with the circuit 52 can be associated sensors such as an accelerometer, gyroscope, pedometer, temperature sensors, GPS, heart rate, Pulse Ox, photo electric, and microphone.

Also attached to the control circuit 52 is a laminate carbon fiber IR heater 58. The heater 58 has an incorporated safety temperature sensor 60 and a heat spreader 62. Optionally, the system can have a display module 64 associated with the control circuit 62.

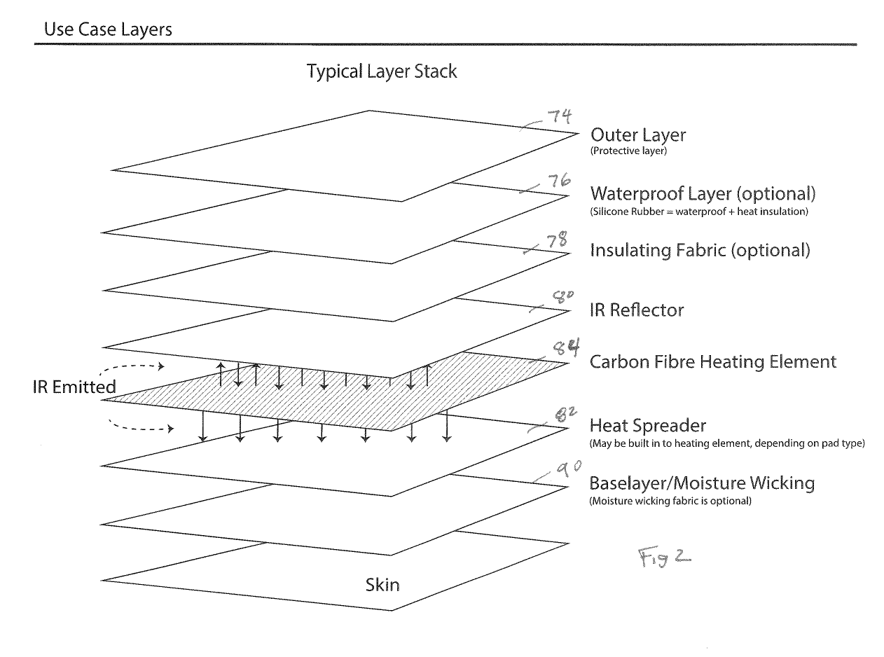

As shown in FIG. 2, a laminate carbon fiber IR heater 58 is formed of several layers which can be positioned adjacent to a user's skin. The laminate structure is intended to be waterproof and distribute heat across a distributed area. The laminate has an outer layer 74 which can be cloth or a polymer. Adjacent to this layer can be a waterproof layer 76 such as silicon rubber or a polymer. Adjacent to the waterproof layer 78 can be an insulating layer configured to minimize heat to the waterproof layer 76. Adjacent to the insulating layer can be a IR reflector layer 80 that functions to reflect IR energy onto a heat reading layer 82. Disposed between the IR reflector layer 80 and the heat spreader layer is a carbon fiber heating element 84. As described below, the carbon fiber heating element 84 can be a yarn or mesh of carbon fibers.

According to the present teachings, the mesh can have between 15-30 carbon fibers fibers per strand. Generally the carbon fiber heating elements should have a resistance between 5 and 15 ohms and preferably about 10 ohms. Preferably, the heating element pad is 5″×4″ with 10 ohm across so 0.5 ohm/sqin.

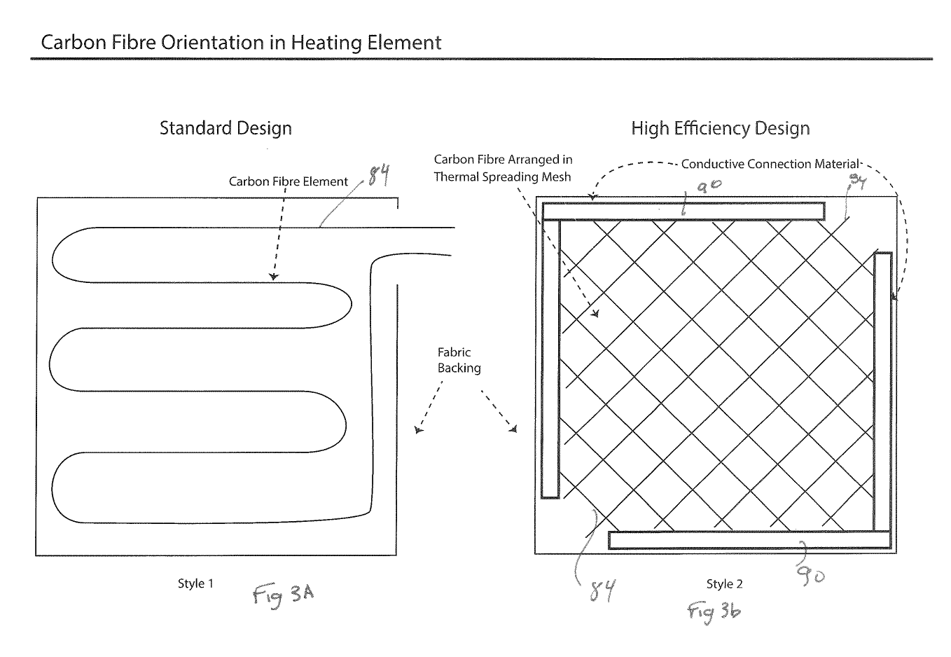

FIGS. 3a and 3b represent two carbon fiber heating elements 84. Each of the designs utilizes a laminate structure similar to the one shown in FIG. 2. The heating element in FIG. 3a utilizes a free floating serpentine heating element formed of a braid of carbon fibers. The diameter of the carbon fiber Braid being about 7 mm. The carbon fiber infrared laminate heater structure. In some embodiments, the infrared laminate heater used in the electrically-heated clothing/pants comprises: an infrared laminate and a conducting element, and the conducting element may further be one of a cable line, a metal alloy foil, a conductive adhesive and a metal oxide semiconductor. In some embodiments, the infrared laminate is used as an insulator to coat the conducting element completely, the infrared laminate may fully absorb thermal energy produced from the conducting element. In some embodiments, the conducting element is a tablet-shaped structure or a plurality of microstructures, and the plurality of microstructures is arranged in a pattern selected from the group consisting of one or more pattern, a spiral pattern, a horseshoe pattern, a herringbone pattern, one or more herringbone pattern, one or more pattern of clustered microstructures, and various combinations thereof. In some embodiments, the conducting element may further be bent to “U” type or “S” type, then placed in the infrared laminate.

In another embodiment, the control element of the electrically-heated clothing/pants and its accessories may further be analog controller, logic circuit and microcontroller, wherein the controller may use a multi-stage switch to regulate the amount electrical power which is transmitted from the at least one battery to the at least one infrared laminate heater, and the control element further include: a processor, a temperature detector and a temperature preventer, wherein the temperature detector is coupled with the processor for detecting and maintaining the temperature of the infrared laminate heater; the temperature preventer is also coupled with the processor, and the temperature preventer will produce another signal to disconnect the power source of the battery.

In one embodiment, while the infrared laminate heater is achieves a constant temperature, the processor or control circuit will receive a signal provided by the temperature detector for regulating other element (e.g. a pulse-width modulator) to achieve a constant temperature of the infrared laminate heater; while the temperature of the infrared laminate heater is abnormal (e.g. excess temperature), the temperature preventer will produce and provide another signal for the processor to disconnect the power source of the battery. In one embodiment, the control element may use three-stage switch to provide the at least one infrared laminate heater for three different temperature ranges. The at least one controller may further be coupled with a light-emitting diode, and the light color of the light-emitting diode indicates the temperature range of the surface of infrared laminate heater, therefore, while using the electrically-heated clothing/pants, the user may know the temperature range of the surface of infrared laminate heater through the light color of the light-emitting diode.

Generally, the laminate carbon fiber heating element has an Input current of 2 A (max) and an Input voltage of 9V-14V (range allowing different on battery source voltages). When using an on-off controller as opposed to a controller powering a duty cycle, an output current: 1.2 (max) and an output voltage of 12V to 16V PWM (boosted and regulated) by having a controller which controls the voltage, Input voltage range is to allow a wide variety of power sources (car battery, LI-Ion battery, etc).

In one embodiment, 12V is the output from the initial power source before regulating/modulating. 16V is the final system power for the heater and is used to keep the current low, which maintains current draw at around 1 A (vs. higher for the competition) which keeps Ah (Amp Hours) lower, resulting in better power efficiency. 12V may still be used to power the controller circuits and/or sensors.

FIGS. 3B and 4 represent a design utilizing a web or screen of Carbon fiber IR emission elements 84. The carbon fiber mesh is made of fibers or braids having a diameter of about 10-15 cross fibers in each direction per inch. Coupled to the carbon fiber mesh is a pair of conductive connection material 90 which is used to conduct power to the heating elements. These elements can be I-shaped or beam members positioned at the periphery of the mesh for a square or rectangular element. For circular elements, the elements can be circular disposed about the periphery with a central electrode in the center. A pad type will be selected based on use case requirements, though the more efficient pad type is favored for most uses. FIG. 4 shows that the control circuit can be disposed within the laminate structure and adjacent the heating elements.

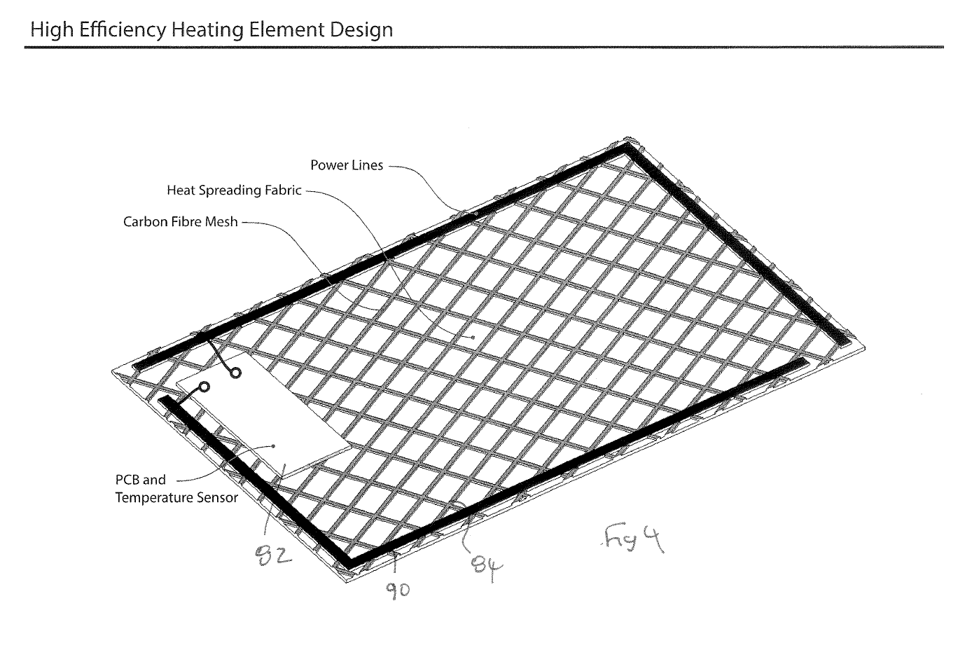

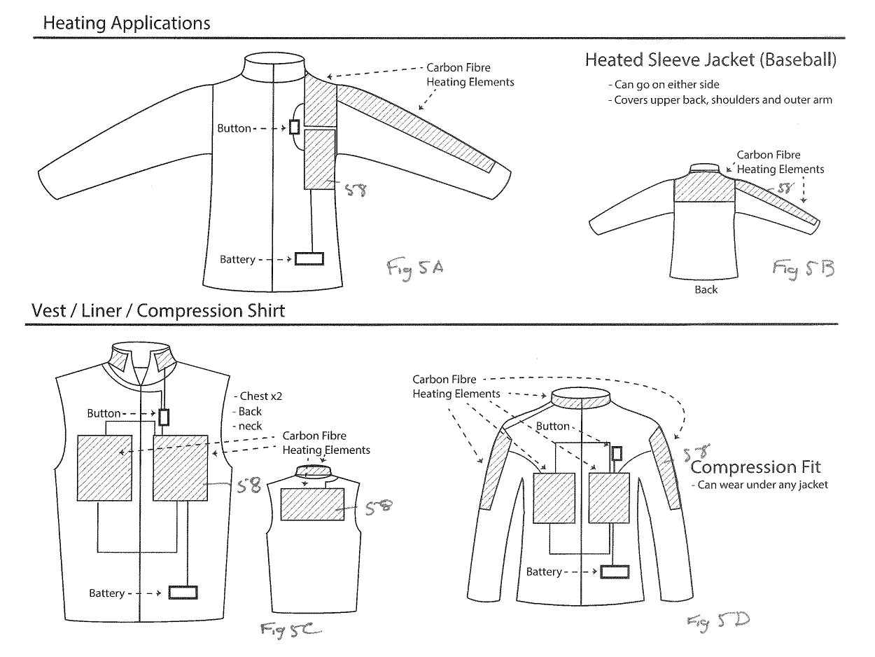

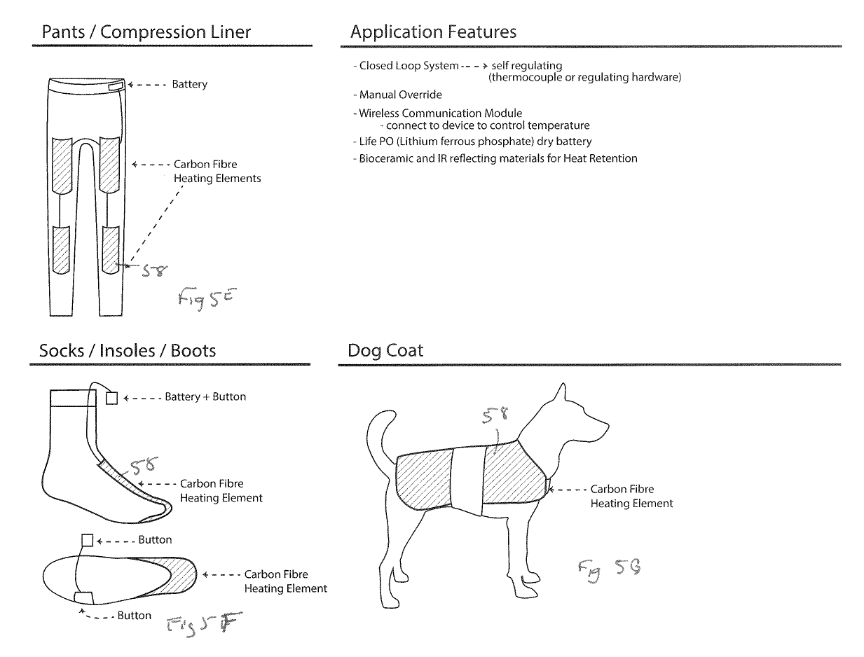

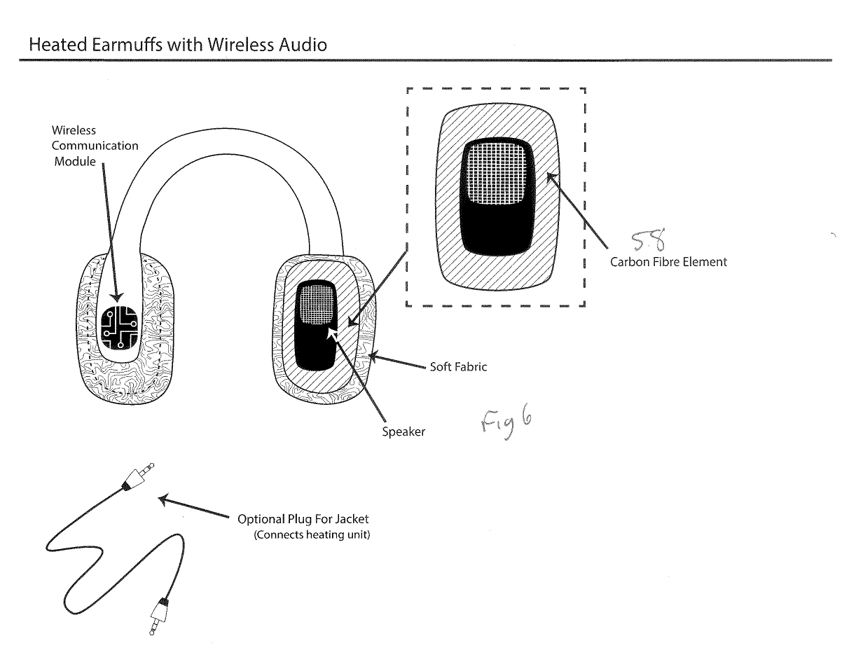

FIG. 5a-5g represent clothing and accessories utilizing the heating elements shown in the provisional application and the structures and circuits shown in FIGS. 1-4. Each embodiment of the electrically-heated clothing further includes: a clothing, at least one battery, at least one infrared laminate heater 82 having an imbedded carbon fiber emitter 84 and at least one control element 104, wherein the at least one control element set on the clothing is electrically connected with at least one battery and at least one infrared laminate heater; wherein the power of at least one battery may be transferred to at least one infrared laminate heater by turning on at least one control element in the form of an infrared carbon fiber emitter 84 for converting electrical power to heat. In one embodiment, wherein a plurality of compartments are sewed on the clothing where the infrared laminate heaters 58 are placed separately in the plurality of pockets.

In some embodiments, there are two pockets sewed on the front of electrically-heated clothing, and there are three pockets sewed on the back of electrically-heated clothing, then the infrared laminate heaters are placed separately in the pockets. The presentation of heaters in the front of electrically-heated clothing is designed for keeping the chest and heart areas warm; additionally, the presentation of infrared laminate heaters in the back of electrically-heated clothing is designed for keeping the back and waist areas warm.

In one embodiment, wherein the at least one battery used by the electrically-heated clothing is the 5V lithium battery. As shown in FIG. 2, it is illustrated as a diagram of basic structure of an electrically-heated pair of pants. The embodiment of the electrically-heated pair of pants further includes: a pair of pants, at least one infrared laminate heater, at least one control element, at least one battery, wherein the at least one control element set on the pants is electrically connected with at least one battery and at least one infrared laminate heater; wherein the power of at least one battery may be transferred to at least one infrared laminate heater by turning on at least one control element for converting electrical power to heat; wherein the at least one battery may be a 5V lithium battery. In one embodiment, wherein a plurality of pockets are sewed on the leg of pants, and the at least one battery is placed separately in the plurality of pockets. In one embodiment, wherein a plurality of pockets are sewed on the electrically-heated pair of pants, several pockets on the seat of pants and several pockets on the leg of pants, and the infrared laminate heaters are placed separately in the plurality of pockets. In one embodiments, the battery used by the electrically-heated pair of pants may be a graphene battery. In another embodiment, wherein the at least one infrared laminate heater of the electrically-heated clothing/pants may be electrically connected with other infrared laminate heaters via a wire.

In some embodiments, there are two pockets sewed on the pair of pants, then the batteries are placed separately in the pockets. In one embodiment, there are three pockets sewed on the pair of pants, one pocket on the seat of pants and two pockets on the leg of pants, then the at least one infrared laminate heater is placed separately in the pockets. The presentation of heaters in the electrically-heated pair of pants is designed for keeping the back of seat and leg areas warm.

In the form of gloves, shoe inserts, or scarves, the electrically-heated accessory according to one embodiment. The embodiment of the electrically-heated accessory further includes: an accessory, at least one carbon fiber (CF) yard or mesh infrared laminate heater, at least one battery, at least one control element, wherein the at least one control element set on the accessory is electrically connected with at least one battery and at least one infrared laminate heater. The power of at least one battery may be transferred to at least one infrared laminate heater by turning on at least one control element for converting electrical power to heat.

There is at least one pocket sewed on the accessory for placing the at least one control element and the at least one battery; wherein a plurality of pockets are sewed on the accessory, and the at least one infrared laminate heater is placed separately in the plurality of pockets. In one embodiment, the accessory may also be the gloves, belt and scarf. In another embodiment, as shown in FIGS. 5f-6, some accessories (e.g. insole and earmuffs) include a bandage, and there is at least one pocket sewed on the bandage for placing at least one battery. In one embodiment, the battery is the 5V lithium battery.

FIG. 6 represents an ear piece using heaters according to the present teachings. Shown is a pair of head phones having a carbon fiber element, having a speaker and a wireless communication module.

The foregoing preferred embodiment of the present invention is illustrative of the present invention rather than limiting the present invention. Having described the invention in connection with a preferred embodiment, modification will now suggest itself to those skilled in the art. Thus, the invention is not to be limited to this embodiment, but rather the invention is intended to cover various modifications and similar arrangements included within the spirit and scope of the appended claims, the scope of which should be accorded the broadest interpretation so as to encompass all such modifications and similar structures. While the preferred embodiment of the invention has been illustrated and described, it will be appreciated that various changes can be made therein without departing from the spirit and scope of the invention.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Various implementations of the systems and methods described here can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications, scripts, or program code) include machine instructions, for a programmable processor, and can be implemented in a high-level procedural and/or object-oriented programming language, and/or in assembly/machine language. The computer programs can be structured functionality in units referenced as “modules”. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter affecting a machine-readable propagated signal, or a combination of one or more of them. The terms “data processing apparatus”, “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

One or more aspects of the disclosure can be implemented in a computing system that includes a backend component, e.g., as a data server, or that includes a middleware component, e.g., an application server, or that includes a frontend component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specifics, these should not be construed as limitations on the scope of the disclosure or of what may be claimed, but rather as descriptions of features specific to particular implementations of the disclosure. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Upon reading this disclosure, those of skill in the art will appreciate still additional alternative structural and functional designs for a system and a process for deep search in computing environments through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. An electrically-heated clothing, comprising:
a clothing;
at least one battery;
at least one carbon infrared laminate heater including, an infrared laminate and a carbon fiber mesh conducting element;
at least one control circuit disposed within the clothing, electrically connected with the at least one battery and the at least one carbon fiber mesh conducting element;
a temperature sensor coupled with the control circuit for detecting and controlling emissions from the of infrared laminate heater;
a safety circuit, configured to determine if the emissions from carbon fiber mesh conducting element is abnormal, the safety circuit configured to produce a first signal which is used by the control circuit to interrupt current flow between the power source of at least one battery and the infrared laminate heater.

2. The clothing of claim 1, wherein the at least one infrared laminate heater comprises an outer layer, a waterproof layer, an insulating fabric, and IR reflective layer, a heat spreader layer, and a moisture wicking layer.

3. The clothing of claim 2, wherein the conducting element is one of cable line, metal alloy foil, conductive adhesive or metal oxide semiconductor.

4. The clothing of claim 3, wherein the clothing defines a plurality of pockets and wherein the infrared laminate heater is selectively disposed within one of the plurality of pockets.

5. The clothing of claim 1, wherein the conducting element is further bent to “U” type or “S” type and placed in the infrared laminate.

6. The clothing of claim 1, wherein the holes of infrared laminate of the infrared laminate heater are 7.5 about 8.5 mm in diameter.

7. The clothing of claim 1, wherein the holes of the infrared laminate of infrared laminate heater are 8 mm in diameter.

8. The clothing of claim 1, wherein there are several pockets sewed on the front of clothing, then the at least one battery is placed separately in the pockets.

9. The pants of claim 2, wherein the clothing is a pair of pants, then the at least one battery is placed separately in the pockets.

10. The pants of claim 2, wherein the carbon fiber element is disposed on a fabric layer in a pattern selected from the group consisting of one or more pattern, a spiral pattern, a horseshoe pattern, a herringbone pattern.

11. The clothing of claim 1, wherein control circuit regulates the amount electrical power which is transmitted from the at least one battery.

12. An electrically-heated accessory, comprising:
an accessory defining at least one chamber;
at least one battery;
at least one carbon fiber infrared laminate heater disposed within the chamber, the at least one infrared laminate heater including an infrared laminate and a carbon fiber conducting element;
at least one control circuit coupled to the accessory and electrically connected with the at least one battery and the at least one mesh carbon fiber infrared laminate heater, and
a temperature detector coupled with the control circuit for detecting and maintaining the temperature of infrared laminate heater.

13. The accessory of claim 12, wherein the accessory is one of a belt, gloves and scarf and the mesh carbon fiber heating element is disposed within the chamber.

14. The accessory of claim 12, wherein the accessory is one of an insole or earmuffs.

15. The accessory of claim 12, wherein the carbon fiber conducting element is one of a wire mesh and a serpentine carbon fiber yard.
